(19) United States
(12) Patent Application Publication
(10) Pub. No.: US 2026/0196434 A1
(43) Pub. Date: Jul. 9, 2026

(54) ELECTROMAGNETIC RELAY

(71) Applicant: OMRON Corporation, Kyoto-shi, Kyoto (JP)

(72) Inventors: Takeshi NISHIDA, Kyoto-shi, Kyoto (JP); Ayaka MIYAKE, Kyoto-shi, Kyoto (JP); Wei TAN, Kyoto-shi, Kyoto (JP); Katsuya JINNO, Kyoto-shi, Kyoto (JP)

(21) Appl. No.: 19/134,215

(22) PCT Filed: Nov. 20, 2023
(86) PCT No.: PCT/JP2023/041579

§ 371 Date: May 30, 2025

(30) Foreign Application Priority Data
Dec. 6, 2022 (JP) 2022-195085

(51) Int. Cl. H01H 50/58; H01H 50/14; H01H 50/36; H01H 50/54; H01H 50/64

(52) U.S. Cl. CPC H01H 50/58; H01H 50/14; H01H 50/36; H01H 50/546; H01H 50/642; H01H 2050/367

(57) ABSTRACT

An electromagnetic relay includes a contact device and a drive device. The contact device includes plural contact sets. Each set comprises a first fixed terminal including a first fixed contact, a second fixed terminal including a second fixed contact, and a movable contact piece. The movable contact piece includes a first movable contact, a second movable contact, a first movable-contact support portion, a central portion, and a first extension portion. The drive device moves the movable contact pieces of the respective contact sets in a second direction. The central portion has a first surface in a contact direction from the first movable contact toward the first fixed contact, and a second surface opposite the first surface. The first extension portion is located between the first movable-contact support portion and the central portion. The second surface of the central portion is positioned beyond the first movable contact in the contact direction.

### CROSS-REFERENCE TO RELATED APPLICATIONS

This application is the U.S. National Phase of International Application No. PCT/JP2023/041579, filed on Nov. 20, 2023. That application claims priority to Japanese Patent Application No. 2022-195085, filed Dec. 6, 2022. The contents of those two applications are incorporated by reference herein in their entireties.

### FIELD

The claimed invention relates to an electromagnetic relay.

### BACKGROUND

Japanese Patent Application Publication No. H06-012956 discloses an electromagnetic relay that includes a contact device having a plurality of contact sets, each set comprising a pair of fixed contacts and a movable contact piece including a pair of movable contacts, and a drive device configured to move the movable contact piece. The plurality of contact sets are arranged in the direction of movement of the movable contact piece relative to the base.

In equipment using an electromagnetic relay provided with a contact device including a plurality of contact sets, when a large current occurs due to a short circuit, the current flows through the contact device, thereby generating an electromagnetic repulsive force between the contacts. This force may cause the contacts to separate. To decrease the separation of the contacts, for example, the electromagnetic force of the drive device may be increased. However, in this case, the drive device becomes larger, resulting in an increase in the overall size of the electromagnetic relay.

### SUMMARY

An object of the claimed invention is to decrease the separation between contacts due to electromagnetic repulsive force while restraining an increase in the size of the electromagnetic relay, in an electromagnetic relay provided with a contact device including a plurality of contact sets, each set comprising a pair of fixed contacts and a movable contact piece including a pair of movable contacts.

An electromagnetic relay according to one embodiment of the claimed invention includes a contact device and a drive device. The contact device includes a plurality of contact sets, each of the plurality of contact sets comprising a first fixed terminal including a first fixed contact, a second fixed terminal including a second fixed contact, and a movable contact piece. The second fixed contact is spaced apart from the first fixed contact in a first direction. The movable contact piece includes a first movable contact facing the first fixed contact in a second direction orthogonal to the first direction, and a second movable contact facing the second fixed contact in the second direction. The plurality of contact sets are arranged in the second direction. The drive device is configured to move the movable contact pieces of the respective contact sets in the second direction. The movable contact piece further includes a first movable-contact support portion, a central portion, and a first extension portion. The first movable-contact support portion supports the first movable contact. The central portion is located at the center of the movable contact piece in the first direction. The central portion has a first surface in a contact direction from the first movable contact toward the first fixed contact, and a second surface opposite the first surface. The first extension portion extends in a direction intersecting the first direction and is positioned between the first movable-contact support portion and the central portion. The second surface of the central portion is disposed at a position beyond the first movable contact in the contact direction.

In this electromagnetic relay, the second surface of the central portion of the movable contact piece is disposed at a position beyond the first movable contact in the contact direction. The first extension portion of the movable contact piece, which is located between the first movable-contact support portion and the central portion, extends in a direction intersecting the first direction. Accordingly, a magnetic field is generated by the current flowing through the first extension portion of the movable contact piece and acts on the current flowing through the central portion of the movable contact piece. As a result, a first Lorentz force is generated. The first Lorentz force acts on the movable contact piece in the contact direction. That is, since the first Lorentz force acts in a direction opposite to the electromagnetic repulsion force between the contacts of the first fixed contact and the first movable contact, the electromagnetic repulsion force can be decreased. With this configuration, an increase in the overall size of the electromagnetic relay can be restrained, for example, compared to a case where the electromagnetic force of the drive device is increased to reduce the separation between contacts. In addition, for example, compared to a case where the movable contact piece extends linearly in the first direction, the required gap between the first fixed contact and the first movable contact can be secured in a space-saving manner.

The first extension portion of the movable contact piece may overlap the first fixed contact when viewed from the first direction. In this case, the magnetic field generated by the current flowing through the first extension portion effectively acts on the current flowing through the central portion of the movable contact piece, and thereby the first Lorentz force increases.

The first fixed terminal may further include a fixed-contact support portion configured to support the first fixed contact. The central portion of the movable contact piece may overlap the fixed-contact support portion when viewed from the second direction in a state where the first movable contact is in contact with the first fixed contact. In this case, the magnetic field generated by the current flowing through the first extension portion effectively acts on the current flowing through the central portion of the movable contact piece, and thereby the first Lorentz force increases.

The first fixed contact may include a first caulking protrusion protruding in the contact direction beyond the first surface of the central portion of the movable contact piece. In this case, since the movable contact piece is arranged within a range that does not go beyond the first caulking protrusion in the contact direction, the size of the contact device is restrained from increasing.

The electromagnetic relay may further include a contact spring for biasing the first surface of the central portion of the movable contact piece in the contact direction. In this case, the contact pressure of the first movable contact and the second movable contact can be ensured. Furthermore, since the contact spring can be efficiently arranged, any increase in the size of the contact device is unlikely to occur.

The movable contact piece may further include a positioning portion for positioning the contact spring. The positioning portion may be arranged on the second surface of the central portion. In this case, the contact spring can be positioned with a simple structure.

The first extension portion may have a shape curved from the first movable-contact support portion toward the contact direction. In this case, the first extension portion can be easily formed, and the magnetic field generated by the current flowing through the first extension portion effectively acts on the current flowing through the central portion of the movable contact piece, and thereby the first Lorentz force increases.

The movable contact piece may further include a second movable-contact support portion configured to support the second movable contact, and a second extension portion extending in a direction intersecting the first direction and positioned between the central portion and the second movable-contact support portion. In this case, a magnetic field is generated by the current flowing through the second extension portion of the movable contact piece and acts on the current flowing through the central portion of the movable contact piece. As a result, a second Lorentz force is generated. The second Lorentz force acts in a direction opposite to the electromagnetic repulsive force between the second fixed contact and the second movable contact, and thereby the electromagnetic repulsive force can be further decreased.

The plurality of contact sets may include a first contact set and a second contact set arranged adjacent to the first contact set in the contact direction. The first surface of the central portion of the movable contact piece of the first contact set may be disposed at a position not beyond the first fixed terminal of the second contact set, in a state where the first movable contact is in contact with the first fixed contact. In this case, it is easier to ensure insulation between the first and second contact sets.

The first fixed terminal may include a first conductive portion including the first fixed contact, a second conductive portion connected to the first conductive portion and arranged at least partially laterally relative to the movable contact piece in the first direction, and a third conductive portion connected to the second conductive portion and extending in a direction from the first movable contact toward the second movable contact. In this case, a magnetic field is generated by the current flowing through the second conductive portion of the first fixed terminal and acts on the current flowing through the first contact support portion of the movable contact piece. As a result, a third Lorentz force is generated. The third Lorentz force acts in a direction opposite to the electromagnetic repulsive force between the first fixed contact and the first movable contact, and thereby the electromagnetic repulsive force can be further decreased.

The plurality of contact sets may include a first contact set and a second contact set. The first contact set may be configured such that the first movable contact of the first contact set comes into contact with the first fixed contact of the first contact set upon energization. The second contact set may be configured such that the first movable contact of the second contact set separates from the first fixed contact of the second contact set upon energization. In this case, in an electromagnetic relay that includes both a contact set referred to as an a-contact and a contact set referred to as a b-contact, contact separation due to electromagnetic repulsive force can be decreased while any increase in the size of the electromagnetic relay is restrained from increasing.

### BRIEF DESCRIPTION OF THE DRAWINGS

FIG. 1 is a perspective view of an electromagnetic relay.

FIG. 2 is a top view of a contact device.

FIG. 3 is a top view of a contact device.

FIG. 4 is a top view of a first contact set in an open state.

FIG. 5 is a cross-sectional view of a first contact set in a closed state, taken along a plane orthogonal to the up-down direction.

FIG. 6 is a top view of a first contact set in a closed state.

FIG. 7 is a top view of a first contact set and a second contact set.

FIG. 8 is a perspective view of a first contact set according to a modification.

FIG. 9 is a perspective view of a first fixed terminal according to a modification.

FIG. 10 is a top view of a contact device according to a modification.

### DETAILED DESCRIPTION

Hereinafter, an embodiment of an electromagnetic relay 1 according to one aspect of the claimed invention will be described with reference to the drawings. When referring to the drawings, the direction indicated by X (an example of the second direction) will be referred to as the left-right direction, the direction indicated by Y (an example of the first direction) as the front-rear direction, and the direction indicated by Z (an example of the third direction) as the up-down direction. Further, the direction indicated by X1 will be referred to as the rightward direction, X2 as the leftward direction, Y1 as the forward direction, Y2 as the rearward direction, Z1 as the upward direction, and Z2 as the downward direction. These directions are defined for convenience of description, and do not limit the arrangement directions of the electromagnetic relay 1.

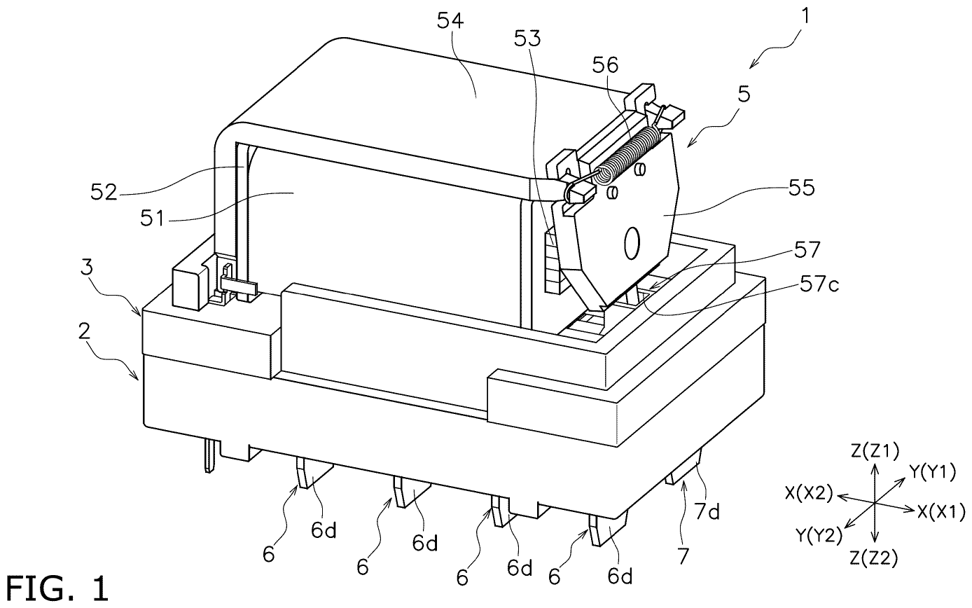

As illustrated in FIGS. 1 to 3, the electromagnetic relay 1 includes a base 2, a partition member 3, a contact device 4, and a drive device 5.

The base 2 and the partition member 3 are comprised of insulating material, such as resin. The base 2 extends in the left-right direction and the front-rear direction. The partition member 3 is disposed above the base 2. The partition member 3 is positioned between the contact device 4 and the drive device 5. In the electromagnetic relay 1, the partition member 3 separates the space in which the contact device 4 is located from the space in which the drive device 5 is located. The partition member 3 is covered from above by a case (not illustrated).

The contact device 4 is housed within the internal space defined by the base 2 and the partition member 3. The contact device 4 includes a plurality of contact sets 10, each set comprising a first fixed terminal 6, a second fixed terminal 7, a movable contact piece 8, and a contact spring 9. The plurality of contact sets 10 are arranged side by side in the left-right direction. The contact sets 10 are spaced apart from each other in the left-right direction.

In the present embodiment, the plurality of contact sets 10 includes four contact sets 10a to 10d. Specifically, the plurality of contact sets 10 includes a first contact set 10a, a second contact set 10b, a third contact set 10c, and a fourth contact set 10d. The second contact set 10b is disposed adjacent to the first contact set 10a in the contact direction. The third contact set 10c is disposed adjacent to the second contact set 10b in the contact direction. The fourth contact set 10d is disposed adjacent to the third contact set 10c in the contact direction. The first to fourth contact sets 10a to 10d are arranged from right to left in the order of the first contact set 10a to the fourth contact set 10d.

The first to fourth contact sets 10a to 10d are the same in configuration. That is, each of the first to fourth contact sets 10a to 10d includes a first fixed terminal 6, a second fixed terminal 7, a movable contact piece 8, and a contact spring 9. Here, among the plurality of contact sets 10, the details of the first fixed terminal 6, the second fixed terminal 7, the movable contact piece 8, and the contact spring 9 of the first contact set 10a will be described.

The first fixed terminal 6 is a plate terminal and is comprised of electrically conductive material. The first fixed terminal 6 is supported by the base 2. For example, the first fixed terminal 6 is fixedly press-fitted to the base 2. The first fixed terminal 6 is situated rearward of the center of the movable contact piece 8 in the front-rear direction.

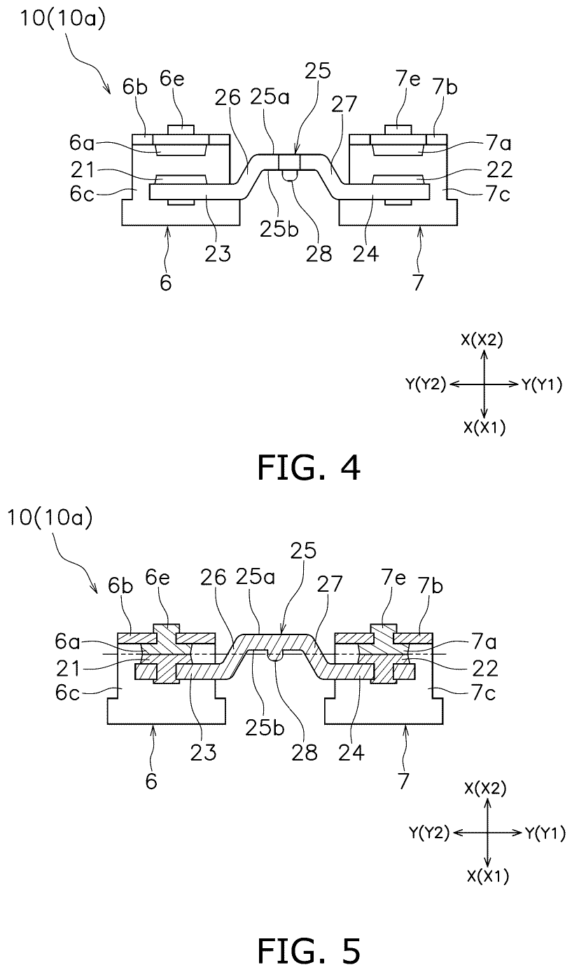

As illustrated in FIGS. 4 and 5, the first fixed terminal 6 includes a first fixed contact 6a, a first contact support portion 6b, a first intermediate portion 6c, and a first external connection portion 6d (see FIG. 1).

The first fixed contact 6a is disposed to the left of the movable contact piece 8. The first fixed contact 6a is arranged on the right surface of the first contact support portion 6b. The first fixed contact 6a is fixed to the first contact support portion 6b by caulking. The first fixed contact 6a includes a first caulking protrusion 6e. The first caulking protrusion 6e protrudes leftward from the left surface of the first contact support portion 6b. It should be noted that the first fixed contact 6a may be formed integrally with the first contact support portion 6b.

The first contact support portion 6b is an example of the fixed-contact support portion. The first contact support portion 6b supports the first fixed contact 6a. The first contact support portion 6b extends in a direction intersecting the left-right direction. The first intermediate portion 6c is disposed between the first contact support portion 6b and the first external connection portion 6d. The first intermediate portion 6c extends in a direction intersecting the up-down direction. The first intermediate portion 6c extends rightward from the lower end of the first contact support portion 6b. The first intermediate portion 6c is placed on the bottom 2b of the base 2. The first external connection portion 6d extends in a direction intersecting the left-right direction. The first external connection portion 6d extends downward from the right end of the first intermediate portion 6c. The first external connection portion 6d protrudes downward from the base 2. The first external connection portion 6d is configured to be connected to an external terminal (not illustrated), such as a bus bar.

The second fixed terminal 7 is a plate terminal and is comprised of conductive material. The second fixed terminal 7 is supported by the base 2. The second fixed terminal 7 is, for example, fixedly press-fitted to the base 2. The second fixed terminal 7 is disposed in front of the center of the movable contact piece 8 in the front-rear direction. The second fixed terminal 7 is spaced apart from the first fixed terminal 6 in the front-rear direction. The second fixed terminal 7 is disposed in front of the first fixed terminal 6.

The second fixed terminal 7 is arranged symmetrically with the first fixed terminal 6. The second fixed terminal 7 has a shape that is symmetrical with the first fixed terminal 6 in the front-rear direction. The second fixed terminal 7 includes a second fixed contact 7a, a second contact support portion 7b, a second intermediate portion 7c, and a second external connection portion 7d (see FIG. 1). The second fixed contact 7a includes a second caulking protrusion 7e. The respective components of the second fixed terminal 7 are the same as those of the first fixed terminal 6, and thus a detailed description thereof is omitted.

The movable contact piece 8 is a plate terminal and is comprised of conductive material. The movable contact piece 8 extends in the front-rear direction. The center portion of the movable contact piece 8 in the front-rear direction has a shape curved convexly toward the left. The longitudinal direction of the movable contact piece 8 corresponds to the front-rear direction. The lateral direction of the movable contact piece 8 corresponds to the up-down direction.

The movable contact piece 8 includes a first movable contact 21, a second movable contact 22, a first contact support portion 23, a second contact support portion 24, a central portion 25, a first extension portion 26, a second extension portion 27, and a positioning portion 28.

The first movable contact 21 is disposed on the left surface of the first contact support portion 23. The first movable contact 21 is arranged opposite the first fixed contact 6a in the left-right direction. The first movable contact 21 is fixed to the first contact support portion 23 by caulking. The first movable contact 21 may be formed integrally with the first contact support portion 23.

The second movable contact 22 is disposed on the left surface of the second contact support portion 24. The second movable contact 22 is arranged opposite the second fixed contact 7a in the left-right direction. The second movable contact 22 is fixed to the second contact support portion 24 by caulking. The second movable contact 22 may be formed integrally with the second contact support portion 24.

The first contact support portion 23 is an example of the first movable-contact support portion. The first contact support portion 23 supports the first movable contact 21. The first contact support portion 23 extends in a direction parallel to the front-rear direction. The first contact support portion 23 is located at the rear end of the movable contact piece 8 in the front-rear direction. The first contact support portion 23 is disposed to the right of the first contact support portion 6b of the first fixed terminal 6. The first contact support portion 23 is disposed above the first intermediate portion 6c of the first fixed terminal 6.

The second contact support portion 24 is an example of the second movable-contact support portion. The second contact support portion 24 supports the second movable contact 22. The second contact support portion 24 extends in a direction parallel to the front-rear direction. The second contact support portion 24 is located at the front end of the movable contact piece 8 in the front-rear direction. The second contact support portion 24 is disposed to the right of the second contact support portion 7b of the second fixed terminal 7. The second contact support portion 24 is disposed above the second intermediate portion 7c of the second fixed terminal 7.

The movable contact piece 8 is configured to be movable in the left-right direction. Specifically, the movable contact piece 8 is configured to move in a contact direction that extends from the first movable contact 21 toward the first fixed contact 6a, and in a separation direction opposite to the contact direction. In the present embodiment, the contact direction corresponds to the leftward direction, and the separation direction corresponds to the rightward direction.

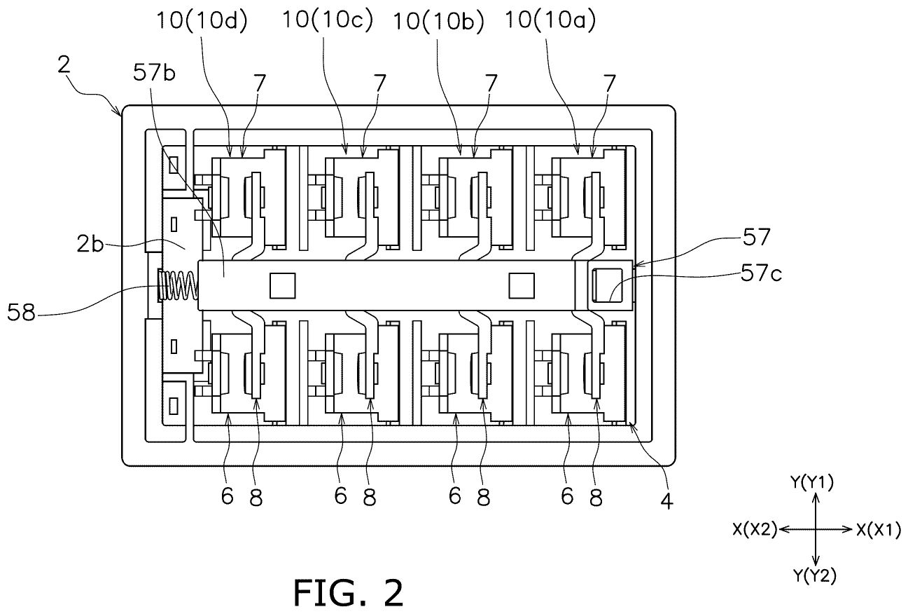

The movable contact piece 8 is movable between an open position illustrated in FIGS. 2 to 4 and a closed position illustrated in FIGS. 5 to 7. In the open position, the first movable contact 21 is separated from the first fixed contact 6a, and the second movable contact 22 is separated from the second fixed contact 7a. In the closed position, the first movable contact 21 is in contact with the first fixed contact 6a, and the second movable contact 22 is in contact with the second fixed contact 7a. In the following description, the “open state” refers to the state in which the movable contact piece 8 is in the open position, and the “closed state” refers to the state in which the movable contact piece 8 is in the closed position.

The central portion 25 is located at the center of the movable contact piece 8 in the front-rear direction. The central portion 25 extends in a direction parallel to the front-rear direction. The central portion 25 also extends in a direction orthogonal to the left-right direction. When viewed from the left-right direction, the central portion 25 is disposed between the first fixed terminal 6 and the second fixed terminal 7. The central portion 25 does not overlap the first fixed terminal 6 or the second fixed terminal 7 when viewed from the left-right direction. In the closed state, the central portion 25 overlaps the first fixed contact 6a and the second fixed contact 7a when viewed from the front-rear direction. In the closed state, the central portion 25 also overlaps the first contact support portion 6b of the first fixed terminal 6 and the second contact support portion 7b of the second fixed terminal 7 when viewed from the front-rear direction. In the open state, the central portion 25 does not overlap the first contact support portion 6b of the first fixed terminal 6 and the second contact support portion 7b of the second fixed terminal 7 when viewed from the front-rear direction.

The central portion 25 includes a first surface 25a and a second surface 25b. The first surface 25a is the left surface of the central portion 25 and faces in the contact direction. The second surface 25b is the surface opposite to the first surface 25a. The second surface 25b is the right surface of the central portion 25 and faces in the separation direction. The first surface 25a and the second surface 25b extend in a direction orthogonal to the left-right direction.

In the closed state, the first caulking protrusion 6e and the second caulking protrusion 7e protrude toward the first surface 25a in the contact direction. In the closed state, the first surface 25a is positioned on the separation direction side relative to the first caulking protrusion 6e and the second caulking protrusion 7e. In the closed state, the first surface 25a overlaps the first contact support portion 6b of the first fixed terminal 6 and the second contact support portion 7b of the second fixed terminal 7, when viewed from the front-rear direction.

The second surface 25b is positioned beyond the first movable contact 21 and the second movable contact 22 in the contact direction. That is, the entire central portion 25 is positioned beyond the first movable contact 21 and the second movable contact 22 in the contact direction. In the closed state, the second surface 25b overlaps the first fixed contact 6a and the second fixed contact 7a when viewed from the left-right direction.

The first extension portion 26 extends in a direction intersecting the front-rear direction. The first extension portion 26 is located between the first contact support portion 23 and the central portion 25. The first extension portion 26 connects the first contact support portion 23 to the central portion 25. The first extension portion 26 extends leftward and forward from the front end of the first contact support portion 23. The first extension portion 26 has a shape curved from the first contact support portion 23 toward the contact direction (leftward). When viewed from the front-rear direction, the first extension portion 26 overlaps the first movable contact 21 and the second movable contact 22. In the closed state, the first extension portion 26 overlaps the first fixed contact 6a and the first contact support portion 6b when viewed from the front-rear direction.

The second extension portion 27 extends in a direction intersecting the front-rear direction. The second extension portion 27 is located between the second contact support portion 24 and the central portion 25. The second extension portion 27 connects the second contact support portion 24 to the central portion 25. The second extension portion 27 extends leftward and rearward from the rear end of the second contact support portion 24. The second extension portion 27 has a shape curved from the second contact support portion 24 toward the contact direction (leftward). When viewed from the front-rear direction, the second extension portion 27 overlaps the first movable contact 21 and the second movable contact 22. In the closed state, the second extension portion 27 overlaps the first fixed contact 6a and the first contact support portion 6b when viewed from the front-rear direction.

The positioning portion 28 is configured to position the contact spring 9. The positioning portion 28 is disposed on the second surface 25b of the central portion 25. The positioning portion 28 is located at the center of the movable contact piece 8 in the front-rear direction. The positioning portion 28 is formed of a protrusion extending rightward from the second surface 25b of the central portion 25.

The contact spring 9 biases the movable contact piece 8 toward the first fixed contact 6a and the second fixed contact 7a. In the present embodiment, the contact spring 9 is disposed on the second surface 25b of the central portion 25 of the movable contact piece 8 so as to bias the movable contact piece 8 in the contact direction. The contact spring 9 is positioned by the positioning portion 28.

The drive device 5 is disposed in an internal space defined by the partition member 3 and the case. The drive device 5 is disposed above the contact device 4. The drive device 5 is configured to move each movable contact piece 8 of the first to fourth contact sets 10a to 10d in the left-right direction. The drive device 5 uses electromagnetic force to cause each movable contact piece 8 of the first to fourth contact sets 10a to 10d to move from the open position to the closed position.

As illustrated in FIGS. 1 and 2, the drive device 5 includes a coil 51, a bobbin 52, a fixed iron core 53, a yoke 54, a movable iron piece 55, a hinge spring 56, a card 57, and a return spring 58. The coil 51 is wound around the bobbin 52. The axis of the bobbin 52 extends in the left-right direction. The fixed iron core 53 is disposed inside the bobbin 52. In the present embodiment, the fixed iron core 53 is formed by laminating a plurality of plates. The yoke 54 has a bent, L-shaped configuration. The yoke 54 is disposed above the coil 51 and to the left of the bobbin 52. The yoke 54 is connected to the left end of the fixed iron core 53.

The movable iron piece 55 is connected to the right end of the yoke 54. The movable iron piece 55 is rotatably supported by the yoke 54 via the hinge spring 56. The movable iron piece 55 rotates using the right end of the yoke 54 as a fulcrum. The movable iron piece 55 is disposed to the right of the fixed iron core 53. The lower end of the movable iron piece 55 is connected to the card 57. The hinge spring 56 biases the movable iron piece 55 away from the fixed iron core 53.

The card 57 is comprised of insulating material such as resin. The card 57 is pressed by the movable iron piece 55 in response to the rotation of the movable iron piece 55 and moves in the left-right direction. The card 57 is mounted on the base 2 and is guided to move in the left-right direction by a guide groove (not illustrated) that is located on the bottom 2b of the base 2. The guide groove extends in the left-right direction.

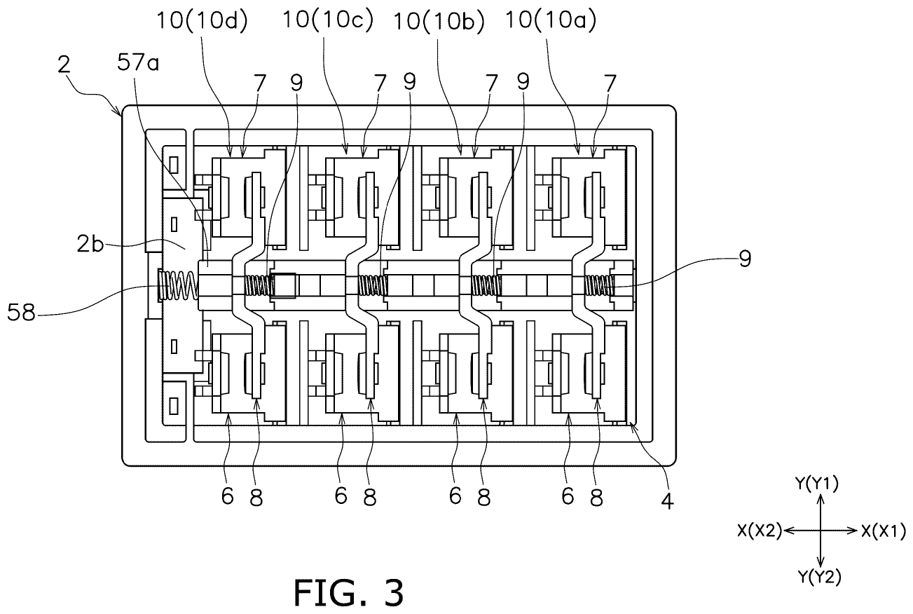

As illustrated in FIGS. 2 and 3, the card 57 includes a card body 57a, a cover portion 57b, and an insertion hole 57c. As illustrated in FIG. 3, the card body 57a includes four spaces for accommodating the movable contact pieces 8 and the contact springs 9 of the first to fourth contact sets 10a to 10d, respectively. The four spaces are arranged in the left-right direction. As illustrated in FIG. 2, the cover portion 57b is fixed to the upper part of the card body 57a and covers the upper sides of the four spaces. The insertion hole 57c is formed in the upper right end of the cover portion 57b. The insertion hole 57c is open upward to receive a part of the movable iron piece 55.

The return spring 58 is disposed at the left end of the card 57 to bias the card 57 in the opening direction.

While no voltage is applied to the coil 51, the card 57 is pushed in the separation direction by the elastic forces of the hinge spring 56 and the return spring 58, such that each movable contact piece 8 of the first to fourth contact sets 10a to 10d is placed in the open position. When a voltage is applied to the coil 51 and the drive device 5 is energized, the movable iron piece 55 is attracted to the fixed iron core 53 and rotates, thereby pressing the card 57 in the contact direction. As a result, the card 57 moves in the contact direction against the elastic force of the return spring 58. As the card 57 moves in the contact direction, each movable contact piece 8 of the first to fourth contact sets 10a to 10d moves to the closed position. Consequently, in each of the first to fourth contact sets 10a to 10d, the first movable contact 21 contacts the first fixed contact 6a, and the second movable contact 22 contacts the second fixed contact 7a. When the application of voltage to the coil 51 is stopped, the card 57 moves in the separation direction by the elastic forces of the hinge spring 56 and the return spring 58. Accordingly, each movable contact piece 8 of the first to fourth contact sets 10a to 10d returns to the open position.

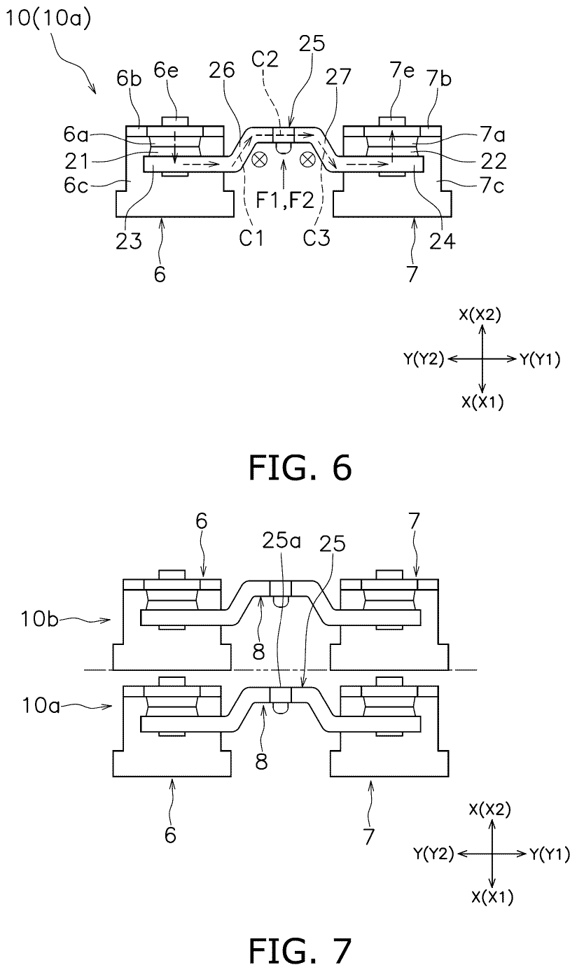

In FIG. 6, an example of a current path through the first fixed terminal 6, the second fixed terminal 7, and the movable contact piece 8 during energization is schematically illustrated by chain-line arrows. In this case, current flows in the order of the first fixed terminal 6, the movable contact piece 8, and the second fixed terminal 7.

As illustrated in FIG. 6, a magnetic field is generated by the current C1 flowing through the first extension portion 26 and acts on the current C2 flowing through the movable contact piece 8. As a result, a first Lorentz force F1 is generated. Similarly, a magnetic field is generated by the current C3 flowing through the second extension portion 27 and acts on the current C2 flowing through the movable contact piece 8. As a result, a second Lorentz force F2 is generated. The first Lorentz force F1 and the second Lorentz force F2 act on the movable contact piece 8 in the contact direction. Since the first and second Lorentz forces F1 and F2 act in a direction opposite to the electromagnetic repulsion forces between the first fixed contact 6a and the first movable contact 21, and between the second fixed contact 7a and the second movable contact 22, the overall electromagnetic repulsion force acting on the movable contact piece 8 can be decreased. As a result, compared to a case in which the electromagnetic force of the drive device 5 is increased to reduce the separation between the first fixed contact 6a and the first movable contact 21 and between the second fixed contact 7a and the second movable contact 22, an increase in the size of the electromagnetic relay 1 is unlikely to occur. In addition, compared to a case in which the movable contact piece 8 extends linearly in the front-rear direction, the required gaps between the first fixed contact 6a and the first movable contact 21 and between the second fixed contact 7a and the second movable contact 22 can be ensured in a space-saving manner.

One embodiment of the electromagnetic relay according to one aspect of the claimed invention has been described above. However, the claimed invention is not limited to the above embodiment, and various modifications may be made without departing from the scope of the claimed invention.

The first surface 25a of the central portion 25 of the movable contact piece 8, in the closed state, may be arranged on the contact direction side relative to the first caulking protrusion 6e and the second caulking protrusion 7e. The second surface 25b of the central portion 25 of the movable contact piece 8, in the closed state, may be arranged so as to overlap the first contact support portion 6b of the first fixed terminal 6 and the second contact support portion 7b of the second fixed terminal 7, when viewed from the left-right direction.

As illustrated in FIG. 7, it is preferable that, in the closed state, the first surface 25a of the central portion 25 of the movable contact piece 8 of the first contact set 10a is arranged at a position not extending beyond the first fixed terminal 6 and the second fixed terminal 7 of the second contact set 10b in the contact direction.

The first extension portion 26 and the second extension portion 27 may extend in a direction parallel to the front-rear direction. The positioning portion 28 may be formed in a shape recessed in the contact direction on the second surface 25b of the central portion 25.

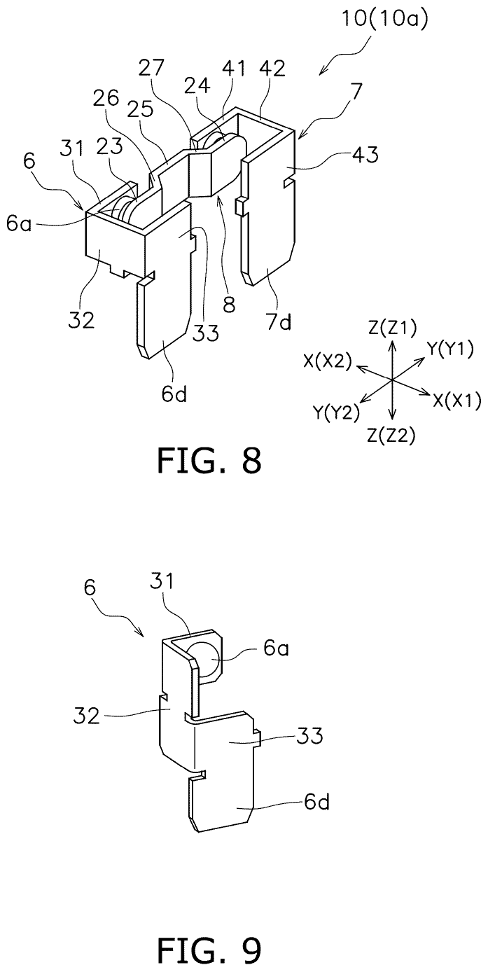

The shapes of the first fixed terminal 6 and the second fixed terminal 7 may be modified. The first fixed terminal 6 and the second fixed terminal 7 may have a shape extending linearly in the up-down direction. As illustrated in FIG. 8, the first fixed terminal 6 and the second fixed terminal 7 may have a shape in which at least a part is arranged laterally relative to the movable contact piece 8 in the front-rear direction. The first fixed terminal 6 illustrated in FIG. 8 includes a first conductive portion 31 including the first fixed contact 6a, a second conductive portion 32, and a third conductive portion 33 including the first external connection portion 6d. The first conductive portion 31 is a portion corresponding to the first contact support portion 6b. The second conductive portion 32 is connected to the first conductive portion 31 and is arranged laterally relative to the rear side of the movable contact piece 8. The third conductive portion 33 is connected to the second conductive portion 32 and extends forward from the right end of the second conductive portion 32. The third conductive portion 33 overlaps the first conductive portion 31 when viewed from the left-right direction. The second fixed terminal 7 illustrated in FIG. 8 includes a first conductive portion 41, a second conductive portion 42, and a third conductive portion 43.

As illustrated in FIG. 9, the third conductive portion 33 may have a notched shape. As illustrated in FIG. 8, the third conductive portion 33 of the first fixed terminal 6 may not overlap the first fixed contact 6a when viewed from the left-right direction. The third conductive portion 33 of the first fixed terminal 6 may also not overlap the first conductive portion 31 when viewed from the left-right direction.

The number of contact sets 10 may vary; two or more contact sets 10 are sufficient.

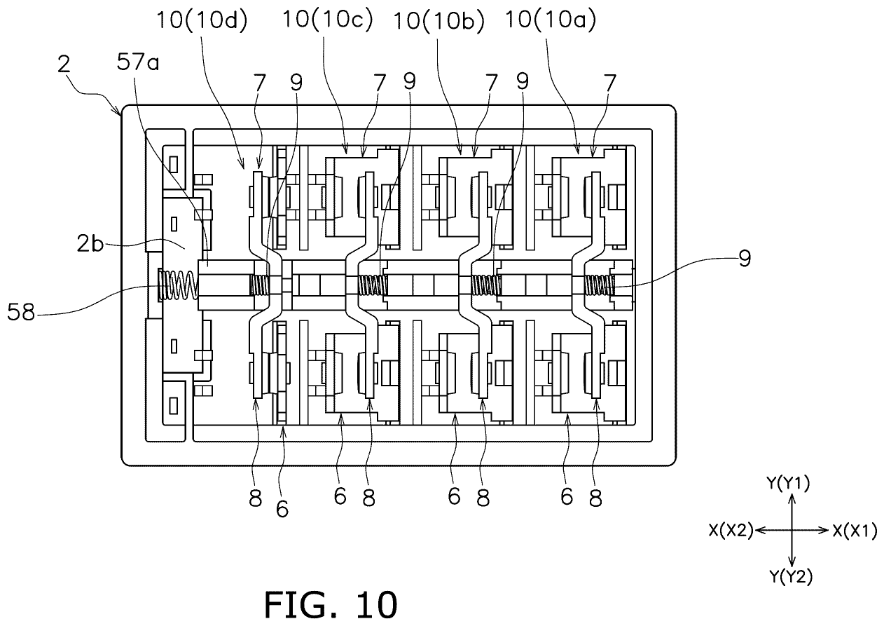

In the embodiment described above, each of the plurality of contact sets 10 enters the closed state when energized and returns to the open state when de-energized. However, as illustrated in FIG. 10, a configuration is possible in which at least one of the plurality of contact sets 10 (in this case, the fourth contact set 10d) enters the open state when energized and is in the closed state when de-energized.

### REFERENCE NUMERALS

1: Electromagnetic relay, 6: First fixed terminal, 6a: First fixed contact, 6b: First contact support portion (an example of fixed-contact support portion), 7: Second fixed terminal, 7a: Second fixed contact, 8: Movable contact piece, 9: Contact spring, 10: Plurality of contact sets, 10a: First contact set, 10b: Second contact set, 21: First movable contact, 22: Second movable contact, 23: First contact support portion (an example of first movable-contact support portion), 24: Second contact support portion (an example of second movable-contact support portion), 25: Central portion, 25a: First surface, 25b: Second surface, 26: First extension portion, 27: Second extension portion, 28: Positioning portion, 31: First conductive portion, 32: Second conductive portion, 33: Third conductive portion

1. An electromagnetic relay, comprising:
a contact device including a plurality of contact sets, each of the plurality of contact sets including a first fixed terminal, a second fixed terminal, and a movable contact piece, the first fixed terminal including a first fixed contact, the second fixed terminal including a second fixed contact spaced apart from the first fixed contact in a first direction, the movable contact piece including a first movable contact and a second movable contact, the first movable contact facing the first fixed contact in a second direction orthogonal to the first direction, the second movable contact facing the second fixed contact in the second direction, the plurality of contact sets being arranged in the second direction; and
a drive device configured to move the movable contact pieces of the respective contact sets in the second direction,
wherein the movable contact piece further includes:
a first movable-contact support portion configured to support the first movable contact;
a central portion positioned at the center of the movable contact piece in the first direction, the central portion has a first surface in a contact direction from the first movable contact toward the first fixed contact and a second surface opposite the first surface; and
a first extension portion extending in a direction intersecting the first direction, the first extension portion being positioned between the first movable-contact support portion and the central portion, and
wherein the second surface of the central portion is disposed at a position beyond the first movable contact in the contact direction.

2. The electromagnetic relay according to claim 1, wherein
the first extension portion overlaps the first fixed contact when viewed from the first direction.

3. The electromagnetic relay according to claim 1, wherein
the first fixed terminal further includes a fixed-contact support portion configured to support the first fixed contact;
the central portion of the movable contact piece overlaps the fixed-contact support portion when viewed from the second direction, in a state where the first movable contact is in contact with the first fixed contact.

4. The electromagnetic relay according to claim 1, wherein
the first fixed contact includes a first caulking protrusion protruding beyond the first surface of the central portion of the movable contact piece in the contact direction.

5. The electromagnetic relay according to claim 1, further comprising:
a contact spring configured to bias the first surface of the central portion of the movable contact piece in the contact direction.

6. The electromagnetic relay according to claim 5, wherein
the movable contact piece further includes a positioning portion configured to position the contact spring, and
the positioning portion is arranged on the second surface of the central portion.

7. The electromagnetic relay according to claim 1, wherein
the first extension portion has a shape curved from the first movable-contact support portion toward the contact direction.

8. The electromagnetic relay according to claim 1, wherein
a second movable-contact support portion configured to support the second movable contact; and
a second extension portion extending in a direction intersecting the first direction, the second extension portion being positioned between the central portion and the second movable-contact support portion.

9. The electromagnetic relay according to claim 1, wherein
the plurality of contact sets includes a first contact set and a second contact set arranged adjacent to the first contact set in the contact direction, and
the first surface of the central portion of the movable contact piece of the first contact set is disposed at a position not beyond the first fixed terminal of the second contact set in the contact direction, in a state where the first movable contact is in contact with the first fixed contact.

10. The electromagnetic relay according to claim 1, wherein
the first fixed terminal includes:
a first conductive portion including the first fixed contact;
a second conductive portion connected to the first conductive portion, the second conductive portion being arranged, at least in part, laterally relative to the movable contact piece in the first direction; and
a third conductive portion connected to the second conductive portion, the third conductive portion extending in a direction from the first movable contact toward the second movable contact.

11. The electromagnetic relay according to claim 1, wherein
the plurality of contact sets includes a first contact set and a second contact set,
the first movable contact of the first contact set comes into contact with the first fixed contact of the first contact set upon energization, and
the first movable contact of the second contact set separates from the first fixed contact of the second contact set upon energization.
